(19) United States
(12) Patent Application Publication
(10) Pub. No.: US 2023/0353234 A1
(43) Pub. Date: Nov. 2, 2023

(54) TRANSMISSION LATENCY COMPENSATION METHOD, APPARATUS, COMMUNICATION DEVICE AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/025,841

(22) PCT Filed: Sep. 25, 2020
(86) PCT No.: PCT/CN2020/117838

§ 371 Date: Mar. 10, 2023

(51) Int. Cl. H04B 7/185; H04W 56/00

(52) U.S. Cl. CPC H04B 7/18519; H04W 56/005

(57) ABSTRACT

In a transmission latency compensation method, a user equipment (UE) determines, based on received compensation duration indication information, a compensation duration from a compensation duration range associated with a service satellite, where the compensation duration is for compensating transmission latency of transmission between the UE and a base station.

### CROSS-REFERENCE TO RELATED APPLICATION

The present application is a U.S. National Stage of International Application No. PCT/CN2020/117838 filed on Sep. 25, 2020, the entire content of which is incorporated herein by reference for all purposes.

### TECHNICAL FIELD

The present disclosure relates to, but is not limited to the field of wireless communication technologies, and particularly relates to transmission latency compensation methods and apparatuses, communication devices and storage media.

### BACKGROUND

In scenario studies such as Non-Terrestrial Networks (NTN, Non-Terrestrial Networks) of cellular mobile communication technologies, satellite communication is considered to be an important aspect of development of future cellular mobile communication technologies. The satellite communication refers to communication carried out by terrestrial cellular mobile communication devices using satellites as relays. The satellite communication system includes a satellite part and a terrestrial part. Characteristics of the satellite communication include: large communication range; communication being carried out between any two points as long as they are within a range covered by radio waves emitted by a satellite; and not easily affected by land disasters.

### SUMMARY

In view of above, embodiments of the present disclosure provide transmission latency compensation methods and apparatuses, communication devices, and storage media.

According to a first aspect of the embodiments of the present disclosure, there is provided a transmission latency compensation method, which is performed by a user equipment (UE), and the method includes: based on received compensation duration indication information, determining a compensation duration from a compensation duration range associated with a service satellite, where the compensation duration is for compensating transmission latency of transmission between the UE and a base station.

According to a second aspect of the embodiments of the present disclosure, there is provided a transmission latency compensation method, which is performed by a satellite, and the method includes: transmitting compensation duration indication information, where the compensation duration indication information is for a user equipment (UE) to determine a compensation duration from a compensation duration range associated with the satellite, and the compensation duration is for compensating transmission latency of transmission between the UE and a base station.

According to a third aspect of the embodiments of the present disclosure, a communication device is provided, the communication device includes a processor, a memory and an executable program stored in the memory and capable of being executed by the processor, where when the processor executes the executable program, the method according to the first aspect is implemented.

According to a fourth aspect of the embodiments of the present disclosure, a communication device is provided, the communication device includes a processor, a memory and an executable program stored in the memory and capable of being executed by the processor, where when the processor executes the executable program, the method according to the second aspect is implemented.

It should be understood that the above general descriptions and the following detailed descriptions are merely for exemplary and explanatory purposes, and cannot limit the embodiments of the present disclosure.

### BRIEF DESCRIPTION OF THE DRAWINGS

The accompanying drawings are incorporated in and constitute a part of the present description, illustrate embodiments consistent with the present disclosure and serve to explain the principles of the embodiments in present disclosure together with the description.

FIG. 1 is a schematic structural diagram illustrating a wireless communication system according to an embodiment;

FIG. 2 is a schematic structural diagram illustrating a network structure in an NTN scenario according to an embodiment;

FIG. 3 is a flowchart illustrating a transmission latency compensation method according to an embodiment;

FIG. 4 is a flowchart illustrating another transmission latency compensation method according to an embodiment;

FIG. 5 is a flowchart illustrating still another transmission latency compensation method according to an embodiment;

FIG. 6 is a flowchart illustrating yet another transmission latency compensation method according to an embodiment;

FIG. 7 is a block diagram illustrating a transmission latency compensation apparatus according to an embodiment;

FIG. 8 is a block diagram illustrating another transmission latency compensation apparatus according to an embodiment; and

FIG. 9 is a block diagram illustrating a device for transmission latency compensation according to an embodiment.

### DETAILED DESCRIPTION OF THE EMBODIMENTS

Embodiments will be described in detail here, examples of which are illustrated in the accompanying drawings. When the following description relates to the accompanying drawings, unless specified otherwise, the same numerals in different drawings represent the same or similar elements. The examples described in the following examples do not represent all examples consistent with embodiments of the present disclosure. Rather, they are merely examples of apparatuses, devices and methods that are consistent with some aspects of the embodiments of the present disclosure as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It should also be understood that the term “and/or” used herein includes any and all possible combinations of one or more of the associated listed items.

It shall be understood that, although the terms “first,” “second,” “third,” and the like may be used herein to describe various information, the information should not be limited by these terms. These terms are used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”.

The embodiments of the present disclosure provide transmission latency compensation methods and apparatuses, communication devices, and storage media. A UE determines a compensation duration from a compensation duration range associated with a service satellite based on received compensation duration indication information, where the compensation duration is for compensating transmission latency of transmission between the UE and a base station. In this way, a compensation duration applicable to a current service satellite can be determined from a compensation duration range via compensation duration indication information of the service satellite, which on one hand provides a method to determine the compensation duration, and on the other hand, the compensation durations applicable to different satellites can be determined for different satellites, which improves accuracy of the compensation duration and thus improves communication quality.

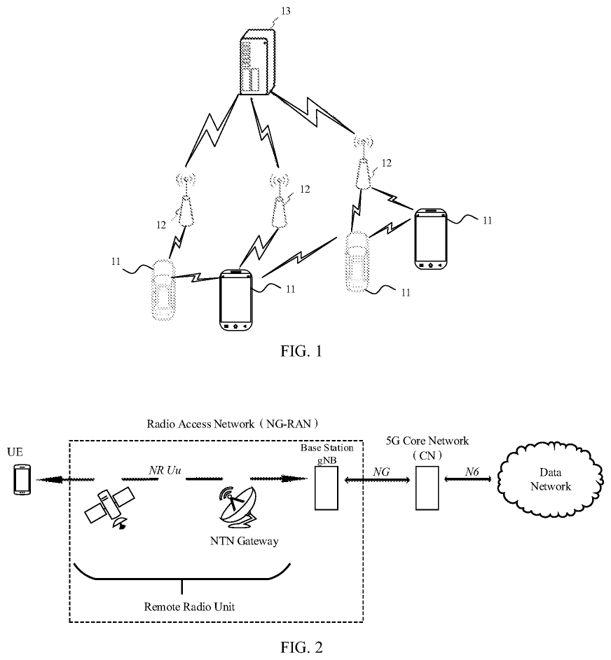

Referring to FIG. 1, a schematic structural diagram of a wireless communication system according to an embodiment is illustrated. As shown in FIG. 1, a wireless communication system is a communication system based on cellular mobile communication technology, the wireless communication system may include: several terminals 11 and several base stations 12.

The terminals 11 may be devices providing voice and/or data connectivity to users. The terminals 11 may communicate with one or more core networks via a Radio Access Network (RAN) and may be IoT terminals such as sensors, mobile phones (also called cellular phones) and computers with IoT terminals, for example, fixed, portable, pocket-sized, handheld, computer-built or vehicle-mounted devices. For example, the terminals 11 may be stations (STAs), subscriber units, subscriber stations, mobile stations, mobiles, remote stations, access points, remote terminals, access terminals, user terminals, user agents, user devices, or user equipments (UEs). Or, the terminals 11 may also be unmanned aerial vehicle devices. Or, the terminals 11 may also be vehicle-mounted devices, for example, trip computers with wireless communication capabilities, or wireless communication devices external connected to trip computers. Or, the terminals 11 can be infrastructures, such as street lights, signal lights or other infrastructures with wireless communication capabilities and the like.

The base stations 12 may be network side devices in the wireless communication system. The wireless communication system may be a 4th generation mobile communication (4G) system, also known as a Long Term Evolution (LTE) system. Or the wireless communication system may be a 5G system, also known as a New Radio (NR) system or 5G NR system. Or, the wireless communication system may be a next-generation system to the 5G system. One of the access networks in the 5G system can be called a NG-RAN (New Generation-Radio Access Network). Or, the wireless communication system may be an MTC system.

The base stations 12 can be evolved base stations (eNBs) as adopted in 4G systems. Or, the base stations 12 can also be base stations (gNBs) in a 5G system with a centralized and distributed architecture. When the base stations 12 adopt the centralized and distributed architecture, a central unit (CU) and at least two distributed units (DUs) are usually included. A protocol stack of a Packet Data Convergence Protocol (PDCP) layer, a Radio Link Control (RLC) layer, and a Media Access Control (MAC) layer is provided in the central unit; and a protocol stack of a PHYsical (PHY) layer is provided in the distributed unit. Embodiments of the present disclosure do not limit the specific implementation of the base stations 12.

The base stations 12 and the terminals 11 can be connected to each other via air interfaces. In different implementations, the air interfaces may be air interfaces based on the fourth generation mobile communication network technology (4G) standard; or, the air interfaces may be air interfaces based on the fifth generation mobile communication network technology (5G) standard, for example, the air interfaces may be New Radios; or, the air interfaces may also be air interfaces based on the next generation mobile communication network technology standard of 5G.

In some embodiments, an E2E (End to End) connection may also be established between the terminals 11 in vehicle to everything (V2X) communication scenarios, such as V2V (vehicle to vehicle) communication, V2I (vehicle to infrastructure) communication, V2P (vehicle to pedestrian) communication and the like.

In some embodiments, the above wireless communication system may also include network management devices 13.

Several base stations 12 are connected to the network management devices 13. The network management devices 13 may be core network devices in the wireless communication system. For example, the network management devices 13 may be Mobility Management Entities (MMES) in an Evolved Packet Core (EPC) network. Or, the network management devices may also be other core network devices such as Serving GateWays (SGWs), Public Data Network GateWays (PGWs), Policy and Charging Rules Function (PCRF) units, Home Subscriber Servers (HSSs) and the like. The embodiments of the present disclosure do not limit the form in which the network management devices 13 can be implemented.

Implementing subjects involved in embodiments of the present disclosure include, but are not limited to, artificial satellites that implement coverage over terrestrial cellular mobile communication networks, and user equipments such as cell phone terminals that employ cellular mobile communication network technique for wireless communication.

An application scenario of the embodiments of the present disclosure is shown in FIG. 2, where in an NTN scenario, a network structure in the case of a satellite-side performing transparent forwarding is as follows: a satellite establishes a communication channel from a terminal to a core network and a Data Network by connecting to a ground station.

In the NTN scenario, transmission from a UE to a base station has to pass through the satellite, the ground station of the satellite, and so on. Since transmission distance is relatively long, transmission latency between the UE and the base station may be relatively high. This has some influence on timing of the communication system.

To alleviate this problem, it is proposed in studies to compensate the transmission latency by introducing a compensation duration, e.g., a Koffset value. For example, for a conventional terrestrial communication system, if a base station transmits an uplink scheduling signaling on slot n to schedule uplink transmission for the PUSCH (physical uplink shared channel), a UE will transmit the PUSCH on slot n+K1. While in the NTN scenario, if a base station transmits an uplink scheduling signaling on slot n to schedule the uplink transmission for the PUSCH, a UE will transmit the PUSCH on slot n+K1+Koffset. The Koffset is for compensating the transmission latency. Based on the same principle, similar compensation mechanisms are to be used for CSI (Channel State Information) feedback, SR (Scheduling Request) transmission, HARQ (Hybrid Automatic Repeat reQuest) transmission, and so on.

A value of the Koffset depends on the transmission latency from the UE to the base station. For satellite communication, different satellites may operate at space orbits with different altitudes, causing various values of the Koffset. In this case, how to determine a practical value of the Koffset is a problem to be solved.

As shown in FIG. 3, this embodiment provides a transmission latency compensation method, the transmission latency compensation method can be performed by a user equipment UE with wireless communication, including the following step 301.

At step 301, based on received compensation duration indication information, a compensation duration is determined from a compensation duration range associated with a service satellite, where the compensation duration is for compensating transmission latency of transmission between the UE and a base station.

The UE may be a cell phone terminal or the like that employs cellular mobile communication network techniques for wireless communication. As shown in FIG. 2, the UE establishes a communication connection with the base station through the transparent forwarding by both the satellite and the ground station of the satellite.

A service satellite can be the satellite currently connecting the UE and the base station. The UE is within a signal coverage area of the service satellite.

The UE may pre-obtain a compensation duration range associated with the service satellite. For example, the compensation duration range of the satellite may be specified by one or more communication protocols.

The compensation duration ranges of different satellites may be different or identical. For example, the compensation duration ranges of satellites in an identical altitude range may be identical, and the compensation duration ranges of satellites in different altitude ranges may be different.

The compensation duration indication information can be transmitted to the UE by the service satellite. Or the base station can directly transmit the compensation duration indication information to the UE when the UE is in the terrestrial network.

The service satellite of the UE can select a specific compensation duration among the compensation duration range. The service satellite can determine a specific compensation duration based on implementing latency for scheduling resources, and/or, requirements of different signaling for latency, and so on.

The compensation duration indication information may not directly indicate a selected compensation duration, and the compensation duration indication information may indicate the compensation duration in a manner of indicating a position of the service selected compensation duration in the compensation duration range. In this way, a number of bits of the compensation duration indication information is reduced and indication efficiency of the compensation duration indication information is improved.

After receiving the compensation duration indication information, the UE determines the specific compensation duration from the compensation duration range and compensates the transmission latency of the transmission between the UE and the base station based on the compensation duration.

The transmission latency of the transmission between the UE and the base station is compensated based on the compensation duration, which may be compensating resources scheduled by the base station using the compensation duration. For example, the compensation duration may delay a starting moment of the resources scheduled by the base station, and so on.

Illustratively, in terrestrial communication, the base station schedules the UE to transmit PUSCH on slot n+K1. In an NTN scenario, a compensation duration range of the service satellite may be from 5 ms to 30 ms, and the compensation duration indication information may indicate a second value within the compensation duration range as a specific compensation duration, e.g., the compensation duration is 6 ms. The UE takes 6 ms as the specific compensation duration based on an indication of the compensation duration indication information. The UE will transmit the PUSCH on slot n+K1+6 ms.

In this way, a compensation duration applicable to a current service satellite can be determined from a compensation duration range via compensation duration indication information of the service satellite, which on one hand provides a method to determine the compensation duration, and on the other hand, the compensation durations applicable to different satellites can be determined for different satellites, which improves accuracy of the compensation duration and thus improves communication quality.

In an embodiment, based on the compensation duration indication information that is received, a compensation duration is determined from the compensation duration range associated with the service satellite, including the following.

Based on a quantified value indicated by the compensation duration indication information, a compensation duration corresponding to the quantified value is determined from the compensation duration range.

The compensation duration range can be quantified. An infinite number of compensation durations included in the compensation duration range are quantified into a finite number of compensation durations. For example, N compensation durations with predetermined time intervals within the compensation duration range can be divided by a quantization constant and then divided results are rounded, so as to obtain N quantified values, where N is a positive integer greater than or equal to 1. The N quantified values and the N compensation durations have a one-to-one correspondence relationship.

The compensation duration indication information can directly indicate a quantified value. The UE can determine a compensation duration corresponding to a quantified value based on the quantified value.

For example, a certain compensation duration range can be quantified into 8 quantified values, thus, 3 bits are to be employed for a compensation duration indication information value to indicate each quantified value.

In this way, a number of bits of the compensation duration indication information is reduced and indication efficiency of the compensation duration indication information is improved.

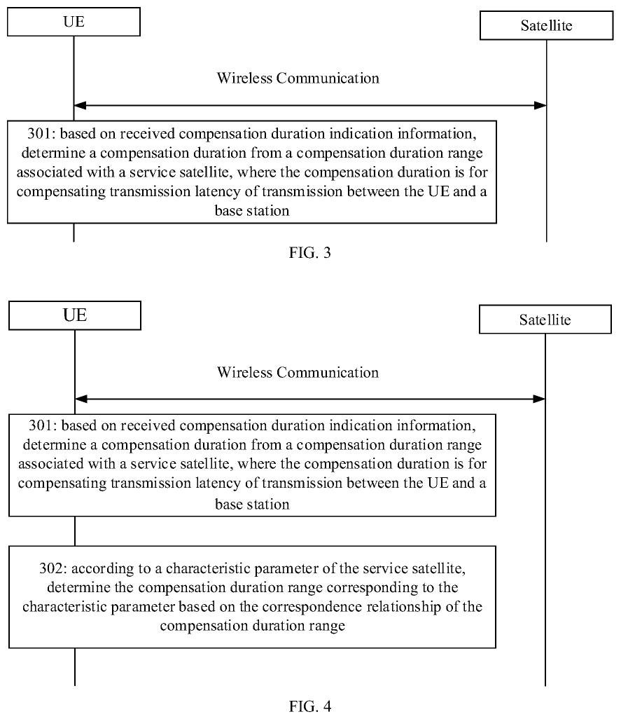

In an embodiment, as shown in FIG. 4, the method includes step 301 and further includes step 302.

At step 302, according to a characteristic parameter of the service satellite, the compensation duration range corresponding to the characteristic parameter is determined based on a correspondence relationship of the compensation duration range.

The characteristic parameter may be one or more parameters for characterizing satellites, for example, the characteristic parameters may indicate a certain altitude range of a satellite orbit. The characteristic parameter may also include one or more parameters that are for uniquely indicating one satellite, for example, the characteristic parameter may be a unique identifier of a satellite.

The correspondence relationship of the compensation duration range can indicate different characteristic parameters and their respective corresponding compensation duration ranges.

The UE can determine the compensation duration range of the service satellite based on the characteristic parameter of the service satellite. In this way, the compensation duration range of the service satellite can be accurately determined and accuracy of the compensation duration that is determined can be improved.

In an embodiment, the characteristic parameter includes: an altitude range of the service satellite and/or a satellite identifier of the service satellite.

The correspondence relationship of the compensation duration range includes at least one of: a correspondence relationship between the altitude range and the compensation duration range; or a correspondence relationship between the satellite identifier and the compensation duration range.

In some examples, the correspondence relationship of the compensation duration range may be the correspondence relationship between the altitude range and the compensation duration range. For example, if the altitude range of the satellite is below 600 km, a corresponding compensation duration range can be from 5 ms to 30 ms. If the altitude range of the satellite is from 600 km to 1200 km, the corresponding compensation duration range can be from 30 ms to 600 ms.

The correspondence relationship of the compensation duration range may be the correspondence relationship between the satellite identifier and the compensation duration range. For example, if a satellite identifier is ID1, a corresponding compensation duration range can be from 5 ms to 30 ms. If the satellite identifier is ID2, the corresponding compensation duration range can be from 30 ms to 600 ms.

The UE may determine the compensation duration range of the service satellite from a correspondence relationship, based on the characteristic parameter of the service satellite, such as the altitude range of the service satellite and/or the satellite identifier of the service satellite.

In an embodiment, the correspondence relationship of the compensation duration range is specified by one or more communication protocols.

The UE can determine the compensation duration range in advance based on a communication protocol, and determine a compensation duration of the service satellite based on the compensation duration range.

In an example, the method further includes the following.

Second indication information indicating the correspondence relationship of the compensation duration range is received.

The correspondence relationship of the compensation duration range can be transmitted to the UE via the service satellite, a base station, and so on. The correspondence relationship of the compensation duration range can be changed based on practical conditions. The transmission via the service satellite or the base station can improve real-time performance of the correspondence relationship of the compensation duration range.

In an embodiment, receiving the second indication information indicating the correspondence relationship of the compensation duration range includes the following.

System information and/or high level signaling and/or physical layer signaling, that carries the second indication information indicating the correspondence relationship of the compensation duration range is received.

The correspondence relationship of the compensation duration range can be transmitted to the UE via broadcast system information and so on.

The correspondence relationship of the compensation duration range may also be transmitted to the UE via high level signaling such as RRC (Radio Resource Control) and the like.

The correspondence relationship of the compensation duration range may also be transmitted to the UE via physical layer signaling such as DCI (Downlink Control Information) and the like.

The second indication information is carried by existing system information, and/or high level signaling, and/or physical layer signaling, which improves utilization efficiency of the existing system information, and/or high level signaling, and/or physical layer signaling.

The base station may also carry the second indication information by using dedicated system information, and/or high level signaling, and/or physical layer signaling.

In an example, the method further includes the following.

First indication information for determining the characteristic parameter transmitted by the service satellite is received. The first indication information can indicate the characteristic parameter directly or indicate information for indirectly determining the characteristic parameter.

In an embodiment, the first indication information for determining the characteristic parameter indicates at least one of: an altitude of the service satellite, where the altitude of the service satellite is to determine an altitude range for the UE where the service satellite is operating; a satellite identifier of the service satellite; or an ephemeris of the service satellite, where the ephemeris of the service satellite is to determine an altitude range for the UE where the service satellite is operating.

The service satellite can transmit a current altitude of the service satellite to the UE, and the UE can determine the compensation duration range based on the correspondence relationship between the altitude range, where the current altitude of the service satellite is in, and the compensation duration range.

The service satellite can transmit the satellite identifier of the service satellite to the UE, and the UE can determine the compensation duration range based on the correspondence relationship between the satellite identifier and the compensation duration range.

The ephemeris can indicate orbit status of the service satellite at different time, and UE can determine a corresponding altitude range based on current orbit status of the service satellite, and further determine the compensation duration range based on the correspondence relationship between the altitude range and the compensation duration range.

In an example, the method further includes the following.

Based on numerology, a compensation duration in an absolute time unit is converted to a compensation duration in a logical time unit.

In communication protocols, resources are usually scheduled by using logical time units such as time slots.

When a unit of a determined compensation duration is a logical time unit, for example, the compensation duration is n time slots, the compensation duration can be directly employed for compensation of transmission latency.

When the unit of the determined compensation duration is an absolute time unit, the compensation duration in a logical time unit can be employed based on current numerology information. For example, when the compensation duration is 10 ms, assuming that the current numerology employed by the PUSCH is 15 kHz, that is, the duration of one time slot is 1 ms, the compensation duration is 10 time slots. In this way, the determined compensation duration can be made compatible with calculation methods of related technologies and calculation convenience is improved.

As shown in FIG. 5, this embodiment provides a transmission latency compensation method, the transmission latency compensation method can be performed by a satellite with wireless communication, including the following step 501.

At step 501: compensation duration indication information is transmitted, where the compensation duration indication information is for a UE to determine a compensation duration from a compensation duration range associated with the satellite, and the compensation duration is for compensating transmission latency of transmission between the UE and a base station.

The UE may be a cell phone terminal or the like that employs cellular mobile communication network techniques for wireless communication. As shown in FIG. 2, the UE establishes a communication connection with the base station through the transparent forwarding by both the satellite and the ground station of the satellite.

The satellite is a service satellite of the UE. The service satellite can be the satellite currently connecting the UE and the base station. The UE is within a signal coverage area of the service satellite. The service satellite can transmit compensation duration indication information to the UE within the signal coverage area.

The UE may pre-obtain the compensation duration range associated with the service satellite. For example, the compensation duration range of the satellite may be specified by one or more communication protocols. The compensation duration ranges of different satellites may be different or identical. For example, the compensation duration ranges of satellites in an identical altitude range may be identical, and the compensation duration ranges of satellites in different altitude ranges may be different.

The service satellite of the UE can select a specific compensation duration among the compensation duration range. The service satellite can determine a specific compensation duration based on implementing latency for scheduling resources, and/or, requirements of different signaling for latency, and so on.

The compensation duration indication information may not directly indicate a selected compensation duration, and the compensation duration indication information may indicate the compensation duration in a manner of indicating a position of the service selected compensation duration in the compensation duration range. In this way, a number of bits of the compensation duration indication information is reduced and indication efficiency of the compensation duration indication information is improved.

After receiving the compensation duration indication information, the UE determines the specific compensation duration from the compensation duration range and compensates the transmission latency of the transmission between the UE and the base station based on the compensation duration.

The transmission latency of the transmission between the UE and the base station is compensated based on the compensation duration, which may be compensating resources scheduled by the base station using the compensation duration. For example, the compensation duration may delay a starting moment of the resources scheduled by the base station, and so on.

Illustratively, in terrestrial communication, the base station schedules the UE to transmit PUSCH on slot n+K1. In an NTN scenario, a compensation duration range of the service satellite may be from 5 ms to 30 ms, and the compensation duration indication information may indicate a second value within the compensation duration range as a specific compensation duration, e.g., the compensation duration is 6 ms. The UE takes 6 ms as the specific compensation duration based on an indication of the compensation duration indication information. The UE will transmit the PUSCH on slot n+K1+6 ms.

In this way, a compensation duration applicable to a current service satellite can be determined from a compensation duration range via compensation duration indication information of the service satellite, which on one hand provides a method to determine the compensation duration, and on the other hand, the compensation durations applicable to different satellites can be determined for different satellites, which improves accuracy of the compensation duration and thus improves communication quality.

In an embodiment, the compensation duration indication information indicates a quantified value corresponding to a compensation duration in the compensation duration range.

The compensation duration range can be quantified. An infinite number of compensation durations included in the compensation duration range are quantified into a finite number of compensation durations. For example, N compensation durations with predetermined time intervals within the compensation duration range can be divided by a quantization constant and then divided results are rounded, so as to obtain N quantified values, where N is a positive integer greater than or equal to 1. The N quantified values and the N compensation durations have a one-to-one correspondence relationship.

The compensation duration indication information can directly indicate a quantified value. The UE can determine a compensation duration corresponding to a quantified value based on the quantified value.

For example, a certain compensation duration range can be quantified into 8 quantified values, thus, 3 bits are to be employed for a compensation duration indication information value to indicate each quantified value.

In this way, a number of bits of the compensation duration indication information is reduced and indication efficiency of the compensation duration indication information is improved.

In an embodiment, as shown in FIG. 6, the method includes step 501 and further includes step 502.

At step 502: first indication information indicating a characteristic parameter of the satellite is transmitted, where the characteristic parameter is to determine a compensation duration range for a UE corresponding to the characteristic parameter based on the correspondence relationship of the compensation duration range.

The first indication information can indicate the characteristic parameter directly or indicate information for indirectly determining the characteristic parameter. The characteristic parameter may be one or more parameters for characterizing satellites, for example, the characteristic parameters may indicate a certain altitude range of a satellite orbit. The characteristic parameter may also include one or more parameters that are for uniquely indicating one satellite, for example, the characteristic parameter may be a unique identifier of a satellite.

The correspondence relationship of the compensation duration range can indicate different characteristic parameters and their respective corresponding compensation duration ranges. The UE can determine the compensation duration range of the service satellite based on the characteristic parameter of the service satellite. In this way, the compensation duration range of the service satellite can be accurately determined and accuracy of the compensation duration that is determined can be improved.

In an embodiment, the characteristic parameter includes: an altitude range of the satellite and/or a satellite identifier of the satellite.

The correspondence relationship of the compensation duration range, includes at least one of: a correspondence relationship between the altitude range and the compensation duration range; or a correspondence relationship between the satellite identifier and the compensation duration range.

In some examples, the correspondence relationship of the compensation duration range may be the correspondence relationship between the altitude range and the compensation duration range. For example, if the altitude range of the satellite is below 600 km, a corresponding compensation duration range can be from 5 ms to 30 ms. If the altitude range of the satellite is from 600 km to 1200 km, the corresponding compensation duration range can be from 30 ms to 600 ms.

The correspondence relationship of the compensation duration range may be the correspondence relationship between the satellite identifier and the compensation duration range. For example, if a satellite identifier is ID1, a corresponding compensation duration range can be from 5 ms to 30 ms. If the satellite identifier is ID2, the corresponding compensation duration range can be from 30 ms to 600 ms.

The UE may determine the compensation duration range of the service satellite from a correspondence relationship, based on the characteristic parameter of the service satellite, such as the altitude range of the service satellite and/or the satellite identifier of the service satellite.

In an embodiment, the first indication information indicates at least one of: an altitude of the satellite, where the altitude of the satellite is for the UE to determine an altitude range in which the satellite is operating; a satellite identifier of the satellite; or an ephemeris of the satellite, where the ephemeris of the satellite is for the UE to determine an altitude range in which the satellite is operating.

The service satellite can transmit a current altitude of the service satellite to the UE, and the UE can determine the compensation duration range based on the correspondence relationship between altitude range where the current altitude of the service satellite is in and the compensation duration range.

The service satellite can transmit the satellite identifier of the service satellite to the UE, and the UE can determine the compensation duration range based on the correspondence relationship between the satellite identifier and the compensation duration range.

The ephemeris can indicate orbit status of the service satellite at different times, and UE can determine a corresponding altitude range based on current orbit status of the service satellite, and further determine the compensation duration range based on the correspondence relationship between the altitude range and the compensation duration range.

In an embodiment, the correspondence relationship of the compensation duration range is specified by one or more communication protocols.

The UE can determine the compensation duration range in advance based on a communication protocol, and determine a compensation duration of the service satellite based on the compensation duration range.

In an example, the method further includes the following.

Second indication information indicating the correspondence relationship of the compensation duration range is transmitted. The correspondence relationship of the compensation duration range can be transmitted to the UE via the service satellite, a base station, and so on. The correspondence relationship of the compensation duration range can be changed based on practical conditions. The transmission via the service satellite or the base station can improve real-time performance of the correspondence relationship of the compensation duration range.

In an embodiment, transmitting the second indication information indicating the correspondence relationship of the compensation duration range includes the following.

System information and/or high level signaling and/or physical layer signaling, that carries the second indication information indicating the correspondence relationship of the compensation duration range is transmitted.

The correspondence relationship of the compensation duration range can be transmitted to the UE via broadcast system information and so on. The correspondence relationship of the compensation duration range may also be transmitted to the UE via high level signaling such as RRC and the like. The correspondence relationship of the compensation duration range may also be transmitted to the UE via physical layer signaling such as DCI and the like.

The second indication information is carried by existing system information, and/or high level signaling, and/or physical layer signaling, which improves utilization efficiency of the existing system information, and/or high level signaling, and/or physical layer signaling.

The base station may also carry the second indication information by using dedicated system information, and/or high level signaling, and/or physical layer signaling.

A specific example is provided below in combination with any of the above embodiments.

This example provides two methods for determining a compensation duration.

### Method 1

A correspondence relationship between different satellite altitudes and the compensation duration range (e.g., a range of Koffset values) is obtained in advance, for example, following correspondence relationships {(below 600 km, from 5 ms to 30 ms), (from 600 km to 12000 km, from 30 ms to 600 ms) are stipulated in a protocol, either are informed through system information or higher level signaling or physical layer signaling.

A terminal determines the range of Koffset values based on ephemeris information or altitude information broadcast by a service satellite, so as to determine the compensation duration (e.g., a specific value of Koffset) based on indication information. For example, if a range of values corresponding to a certain altitude information is quantified as 8 values, the specific value of Koffset can be determined by indication information of 3 bits.

### Method 2

A correspondence relationship between different satellite IDs and the compensation duration range (e.g., a range of Koffset values) is obtained in advance, for example, following correspondence relationships {(ID 1, from 5 ms to 30 ms), (ID 2, from 30 ms to 600 ms) are stipulated in a protocol, either are informed through system information or higher level signaling or physical layer signaling.

A terminal determines a compensation duration, i.e., the range of Koffset values, based on service satellite ID broadcast by a service satellite, so as to determine a specific value of Koffset based on indication information.

A Unit of Koffset can be Related to Specific Operations.

In an implementation, Koffset can be in an absolute time unit, in this case, when calculating a timing relationship, a corresponding number of time slots is to be added to determined operations based on current numerology information. For example, when Koffset is 10 ms, assuming that the current numerology employed by the PUSCH is 15 kHz, that is, a duration of a time slot is 1 ms, thus Koffset corresponds to 10 time slots.

In another implementation, Koffset can also be in a logical time unit, such as n time slots, and in this implementation, Koffset time slots are added directly to the determined operations.

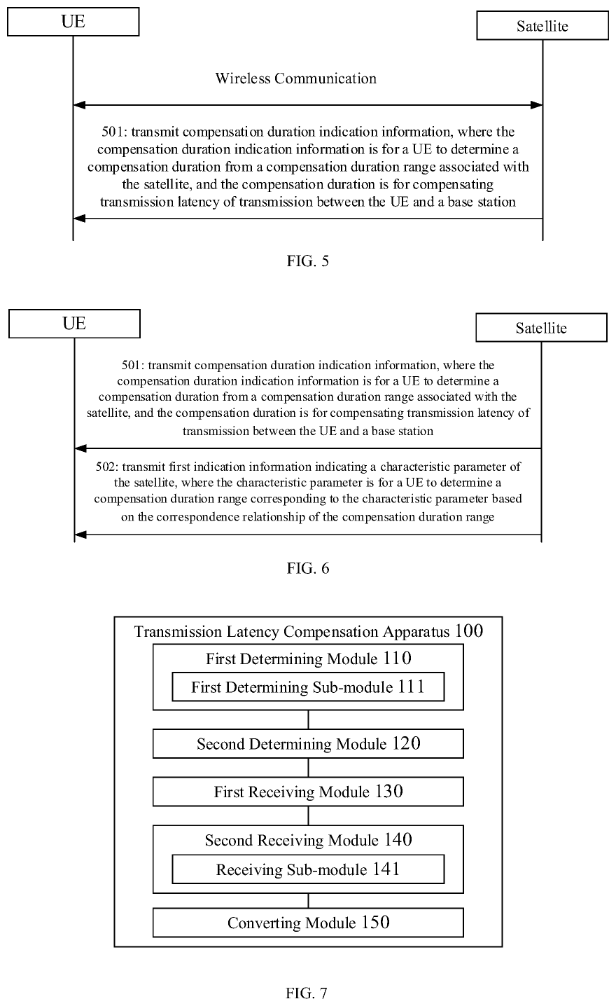

Embodiments of the present disclosure also provide a transmission latency compensation apparatus applied in a UE, as shown in FIG. 7, the transmission latency compensation apparatus 100 includes: a first determining module 110.

The first determining module 110 is configured to determine, based on received compensation duration indication information, a compensation duration from a compensation duration range associated with a service satellite, where the compensation duration is for compensating transmission latency of transmission between the UE and a base station.

In an embodiment, the first determining module 110 includes: a first determining sub-module 111 configured to determine, based on a quantified value indicated by the compensation duration indication information, a compensation duration corresponding to the quantified value from the compensation duration range.

In an embodiment, the apparatus 100 further includes: a second determining module 120 configured to determine, according to a characteristic parameter of the service satellite, a compensation duration range corresponding to the characteristic parameter based on the correspondence relationship of the compensation duration range.

In an embodiment, the characteristic parameter includes: an altitude range of the service satellite and/or a satellite identifier of the service satellite.

The correspondence relationship of the compensation duration range, including at least one of: a correspondence relationship between the altitude range and the compensation duration range; or a correspondence relationship between the satellite identifier and the compensation duration range.

In an embodiment, the apparatus 100 further includes: a first receiving module 130 configured to receive first indication information transmitted by the service satellite for determining the characteristic parameter.

In an embodiment, the first indication information for determining the characteristic parameter indicates at least one of: an altitude of the service satellite, where the altitude of the service satellite is to determine an altitude range for the UE where the service satellite is operating; a satellite identifier of the service satellite; or an ephemeris of the service satellite, where the ephemeris of the service satellite is to determine an altitude range for the UE where the service satellite is operating.

In an embodiment, the correspondence relationship of the compensation duration range is specified by one or more communication protocols.

In an embodiment, the apparatus 100 further includes: a second receiving module 140 configured to receive second indication information indicating the correspondence relationship of the compensation duration range.

In an embodiment, the second receiving module 140 includes: a receiving sub-module 141, configured to receive system information and/or high level signaling and/or physical layer signaling that carry the second indication information indicating the correspondence relationship of the compensation duration range.

In an embodiment, the apparatus 100 further includes: a converting module 150 configured to convert, based on numerology, a compensation duration in an absolute time unit to a compensation duration in a logical time unit.

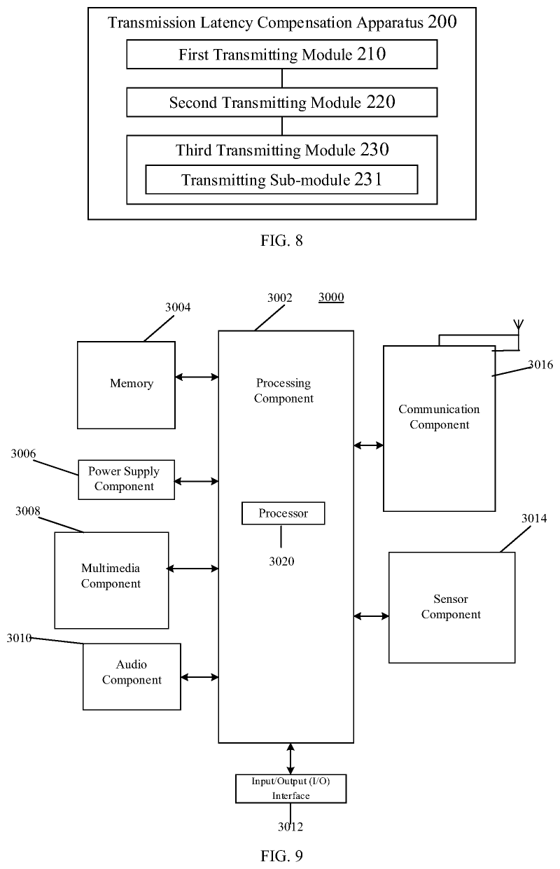

Embodiments of the present disclosure also provide a transmission latency compensation apparatus applied in a satellite, as shown in FIG. 8, the transmission latency compensation apparatus 200 includes: a first transmitting module 210.

The first transmitting module 210 is configured to transmit compensation duration indication information, where the compensation duration indication information is for a UE to determine a compensation duration from a compensation duration range associated with the satellite, the compensation duration is for compensating transmission latency of transmission between the UE and a base station.

In an embodiment, the compensation duration indication information indicates a quantified value corresponding to a compensation duration in the compensation duration range.

In an embodiment, the apparatus 200 further includes: a second transmitting module 220 configured to transmit first indication information indicating a characteristic parameter of the satellite, where the characteristic parameter is to determine a compensation duration range for a UE corresponding to the characteristic parameter based on the correspondence relationship of the compensation duration range.

In an embodiment, the characteristic parameter includes: an altitude range of the satellite and/or a satellite identifier of the satellite.

The correspondence relationship of the compensation duration range, including at least one of: a correspondence relationship between the altitude range and the compensation duration range; or a correspondence relationship between the satellite identifier and the compensation duration range.

In an embodiment, the first indication information indicates at least one of: an altitude of the satellite, where the altitude of the satellite is for the UE to determine an altitude range in which the satellite is operating; a satellite identifier of the satellite; or an ephemeris of the satellite, where the ephemeris of the satellite is for the UE to determine an altitude range in which the satellite is operating.

In an embodiment, the correspondence relationship of the compensation duration range is specified by one or more communication protocols.

In an embodiment, the apparatus 200 further includes: a third transmitting module 230 configured to transmit second indication information indicating the correspondence relationship of the compensation duration range.

In an embodiment, the third transmitting module 230 includes: a transmitting sub-module 231, configured to transmit system information and/or high level signaling and/or physical layer signaling that carry the second indication information indicating the correspondence relationship of the compensation duration range.

In some embodiments, the first determining module 110, the second determining module 120, the first receiving module 130, the second receiving module 140, the converting module 150, the first transmitting module 210, the second transmitting module 220, and the third transmitting module 230 and so on, may be implemented by one or more central processing units (CPUs), graphics processing units (GPUs), baseband processors (BPs), application specific integrated circuits (ASICs), DSPs, programmable logic devices (PLDs), and programmable logic devices (PLDs). GPU (Graphics Processing Unit), baseband processor (BP), application specific integrated circuit (ASIC), DSP, programmable logic device (PLD), complex programmable logic device (CPLD), etc. Programmable Logic Device), Complex Programmable Logic Device (CPLD, Complex Programmable Logic Device), Field-Programmable Gate Array (FPGA, Field-Programmable Gate Array), general-purpose processor, controller, microcontroller (MCU, Micro Controller Unit), Microprocessor, or other electronic components to perform aforementioned methods.

FIG. 9 is a block diagram illustrating a device 3000 for transmission latency compensation according to an embodiment. For example, device 3000 can be a mobile phone, a computer, a digital broadcast terminal, a message transmitting and receiving device, a gaming console, a tablet device, a medical device, a fitness device, a personal digital assistant, and the like.

Referring to FIG. 9, device 3000 can include one or more of the following components: processing component 3002, memory 3004, power supply component 3006, multimedia component 3008, audio component 3010, input/output (I/O) interface 3012, sensor component 3014, and a communication component 3016.

The processing component 3002 usually controls overall operations of the device 3000, such as operations related to display, a telephone call, data communication, a camera operation and a record operation. The processing component 3002 may include one or more processors 3020 to execute instructions to complete all or a part of the steps of the above methods. In addition, the processing component 3002 may include one or more modules which facilitate the interaction between the processing component 3002 and other components. For example, the processing component 3002 may include a multimedia module to facilitate the interaction between the multimedia component 3008 and the processing component 3002.

The memory 3004 is configured to store different types of data to support the operations of the electronic device 3000. Examples of such data include instructions, contact data, phonebook data, messages, pictures, videos, and so on for any application or method that operates on the device 3000. The memory 3004 may be implemented by any type of volatile or non-volatile storage devices or a combination of the above, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 3006 provides power for different components of the electronic device 3000. The power supply component 3006 may include a power management system, one or more power sources, and other components associated with generating, managing and distributing power for the electronic device 3000.

The multimedia component 3008 includes a screen providing an output interface between the device 3000 and the user. In some examples, the screen may include a Liquid Crystal Display (LCD) and a Touch Panel (TP) and so on. If the screen includes the TP, the screen may be implemented as a touch screen to receive input signals from the user. The TP may include one or more touch sensors to sense touches, swipes, and gestures on the TP. The touch sensor may not only sense the boundary of a touch or slide operation but also detect duration and pressure relating to the touch or slide operation. In some examples, the multimedia component 3008 may include a front camera and/or a rear camera. When the device 3000 is in an operation mode, such as a shooting mode or a video mode, the front camera and/or the rear camera can receive external multimedia data. Each of the front camera and the rear camera may be a fixed optical lens system or have focal length and optical zooming capability.

The audio component 3010 is configured to output and/or input an audio signal. For example, the audio component 3010 may include a microphone (MIC). When the electronic device 3000 is in an operating mode, such as a call mode, a recording mode and a speech recognition mode, the microphone is configured to receive an external audio signal. The received audio signal may be further stored in the memory 3004 or sent via the communication component 3016. In some examples, the audio component 3010 may also include a loudspeaker for outputting an audio signal.

The I/O interface 3012 provides an interface between the processing component 3002 and a peripheral interface module. The above peripheral interface module may be a keyboard, a click wheel, a button, or the like. These buttons may include but not limited to, a home button, a volume button, a start button and a lock button.

The sensor component 3014 includes one or more sensors for providing state assessments in different aspects for the device 3000. For example, the sensor component 3014 may detect the on/off state of the electronic device 3000, and relative locations of components, such as a display and a small keyboard of the electronic device 3000. The sensor component 3014 may also detect a position change of the electronic device 3000 or a component of the electronic device 3000, the presence or absence of contact of a user with the electronic device 3000, an orientation or acceleration/deceleration of the electronic device 3000 and a temperature change of the electronic device 3000. The sensor component 3014 may include a proximity sensor for detecting the existence of a nearby object without any physical touch. The sensor component 3014 may also include a Complementary Metal-Oxide-Semiconductor (CMOS) or Charged Coupled Device (CCD) image sensor applied in an imaging application. In some examples, the sensor component 3014 may also include an acceleration sensor, a gyro sensor, a magnetic sensor, a pressure sensor, a temperature sensor, or the like.

The communication component 3016 is configured to facilitate wired or wireless communication between the device 3000 and other devices. The device 3000 can access a wireless network based on a communication standard, such as Wi-Fi, 2G or 3G, or a combination of the above, or the like. In some examples, the communication component 3016 receives a broadcast signal or broadcast related information from an external broadcast management system via a broadcast channel. In some examples, the communication component 3016 may also include a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth® (BT) technology and other technologies.

In an example, the device 3000 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above embodiments.

In an example, a non-transitory computer readable storage medium including instructions, such as the memory 3004 including instructions, is also provided. The above instructions may be executed by the processor 3020 of the device 3000 to complete the above method. For example, the non-transitory computer-readable storage medium may be a ROM, a RAM, a CD-ROM, a magnetic tape, a floppy disc, an optical data storage device, and the like.

Other embodiments of the present disclosure will be readily apparent to those skilled in the art after considering the specification and practicing the contents disclosed herein. The present application is intended to cover any variations, uses, or adaptations of the embodiments of the present disclosure, which follow the general principle of the embodiments of the present disclosure and include common knowledge or conventional technical means in the art that are not disclosed in the embodiments of the present disclosure. The specification and examples are to be regarded as illustrative only. The true scope and spirit of the embodiments of the present disclosure are pointed out by the following claims.

It is to be understood that the embodiments of the present disclosure is not limited to the precise structures described above and shown in the accompanying drawings and may be modified or changed without departing from the scope of the present disclosure. The protection scope of the present disclosure is limited only by the appended claims.

1. A transmission latency compensation method, performed by a user equipment (UE), comprising:
based on received compensation duration indication information, determining a compensation duration from a compensation duration range associated with a service satellite, wherein, the compensation duration is for compensating transmission latency of transmission between the UE and a base station.

2. The method according to claim 1, wherein determining the compensation duration from the compensation duration range associated with the service satellite based on the received compensation duration indication information comprises:
based on a quantified value indicated by the compensation duration indication information, determining the compensation duration corresponding to the quantified value from the compensation duration range.

3. The method according to claim 1, further comprising:
according to a characteristic parameter of the service satellite, determining the compensation duration range corresponding to the characteristic parameter based on a correspondence relationship of the compensation duration range.

4. The method according to claim 3, wherein
the characteristic parameter comprises at least one of an altitude range of the service satellite or a satellite identifier of the service satellite; and
the correspondence relationship of the compensation duration range comprises at least one of:
a correspondence relationship between the altitude range and the compensation duration range; and
a correspondence relationship between the satellite identifier and the compensation duration range.

5. The method according to claim 3, further comprising:
receiving a first indication information for determining the characteristic parameter transmitted by the service satellite.

6. The method according to claim 5, wherein the first indication information for determining the characteristic parameter indicates at least one of:
an altitude of the service satellite, wherein, the altitude of the service satellite is to determine an altitude range for the UE where the service satellite is operating;
a satellite identifier of the service satellite; and
an ephemeris of the service satellite, wherein, the ephemeris of the service satellite is to determine the altitude range for the UE where the service satellite is operating.

7. The method according to claim 3, wherein
the correspondence relationship of the compensation duration range is specified by communication protocols.

8. The method according to claim 3, further comprising:
receiving second indication information indicating the correspondence relationship of the compensation duration range.

9. The method according to claim 8, wherein receiving the second indication information indicating the correspondence relationship of the compensation duration range comprises:
receiving at least one of system information, high level signaling, or physical layer signaling that carries the second indication information indicating the correspondence relationship of the compensation duration range.

10. The method according to claim 1 or 2, further comprising:
based on numerology, converting the compensation duration in an absolute time unit to the compensation duration in a logical time unit.

11. A transmission latency compensation method, performed by a satellite, comprising:
transmitting compensation duration indication information, wherein the compensation duration indication information is for a user equipment (UE) to determine a compensation duration from a compensation duration range associated with the satellite, and the compensation duration is for compensating transmission latency of transmission between the UE and a base station.

12. The method according to claim 11, wherein the compensation duration indication information indicates a quantified value corresponding to the compensation duration in the compensation duration range.

13. The method according to claim 11, further comprising:
transmitting first indication information indicating a characteristic parameter of the satellite, wherein, the characteristic parameter is to determine the compensation duration range for the UE corresponding to the characteristic parameter based on a correspondence relationship of the compensation duration range.

14. The method according to claim 13, wherein
the characteristic parameter comprises at least one of an altitude range of the satellite or a satellite identifier of the satellite; and the correspondence relationship of the compensation duration range comprises at least one of:
a correspondence relationship between the altitude range and the compensation duration range; and
a correspondence relationship between the satellite identifier and the compensation duration range.

15. The method according to claim 14, wherein the first indication information indicates at least one of:
an altitude of the satellite, wherein the altitude of the satellite is to determine an altitude range for the UE where the satellite is operating;
a satellite identifier of the satellite; or
an ephemeris of the satellite, wherein the ephemeris of the satellite is to determine the altitude range for the UE where the satellite is operating.

16. The method according to claim 13, wherein
the correspondence relationship of the compensation duration range is specified by communication protocols.

17. The method according to claim 13, further comprising:
transmitting second indication information indicating the correspondence relationship of the compensation duration range.

18. The method according to claim 17, wherein transmitting the second indication information indicating the correspondence relationship of the compensation duration range comprises:
transmitting at least one of system information, high level signaling or physical layer signaling that carries the second indication information indicating the correspondence relationship of the compensation duration range.

19-36. (canceled)

37. A communication device comprising a processor, a memory and an executable program stored on the memory and capable of being executed by the processor, wherein the processor executes the executable program to implement:
based on received compensation duration indication information, determining a compensation duration from a compensation duration range associated with a service satellite, wherein the compensation duration is for compensating transmission latency of transmission between the UE and a base station.

38. A communication device comprising a processor, a memory and an executable program stored on the memory and capable of being executed by the processor, wherein the processor executes the executable program to implement the method according to claim 11.
